(19) United States
(12) Patent Application Publication
(10) Pub. No.: US 2003/0039261 A1
(43) Pub. Date: Feb. 27, 2003

(54) Portable Mini-hub for local area networks

(76) Inventor: William J. Purpura, Anaheim, CA (US)

Correspondence Address: Harness, Dickey & Pierce, P.L.C., P.O. Box 828, Bloomfield Hills, MI, 48303, US

(21) Appl. No.: 09/934,312

(22) Filed: Aug. 21, 2001

(51) Int. Cl. H04L 12/28

(52) U.S. Cl. 370/408; 370/420

(57) ABSTRACT

A portable network mini-hub is provided that allows users to rapidly set up and configure a portable local area network, regardless of the connection method or available power, in order to share common pay per use mobile Internet services. The portable network mini-hub comprises a wireless module, a plurality of USB ports, a plurality of RJ ports, an Ethernet hub, and a power source, wherein a plurality of network devices communicate through the portable network mini-hub to form a portable local network.

### FIELD OF THE INVENTION

The present invention relates generally to local area networks and more particularly to devices that establish a local area network such that a plurality of network devices may share common pay per use mobile Internet services.

### BACKGROUND OF THE INVENTION

Existing systems that receive pay per use Internet services commonly provide for sharing of a connection to the Internet services amongst multiple network devices for cost efficiency. For example, current Microsoft® Windows 98/2000 software technology allows users to share one Internet connection with multiple devices operating on a local network. More specifically, an Internet Connection Sharing function is provided in the Windows operating system such that one computer, hereinafter referred to as the Connection Sharing Computer, manages communications with the Internet services amongst a plurality of network devices, e.g. personal computers.

Generally, the Connection Sharing Computer establishes an initial, charged local area network (LAN) connection. The Connection Sharing Computer then serves as a controlling device for the LAN by providing Internet Protocol (IP) addresses and name resolution services for other computers on the LAN, hereinafter referred to as network devices. The network devices may then access the Internet through the Connection Sharing Computer using private IP addressing translation. More specifically, when a network device on the network sends a request to the Internet, its private address is transmitted to the Connection Sharing Computer, and the Connection Sharing Computer then translates the IP address of the network device to its own Internet IP address and then sends it on to the Internet.

Private IP addressing translation occurs when automatic addressing is enabled, which allows the Connection Sharing Computer to use Dynamic Host Configuration Protocol (DHCP) to dynamically assign private IP address to all network devices on a LAN. A user may disable automatic addressing and statically assign an IP address to each network device on the LAN if DHCP is not used, which is common in many European countries. Further, the Connection Sharing Computer may also use sharing features to allow outside users on the Internet to access web sites, e-mail, and game servers that are hosted on the LAN.

To enable Internet Connection Sharing, all network devices on the LAN must have network adapters. One network device is the Connection Sharing Computer, which serves to establish a connection to the Internet using the method offered by the pay per use system, wherein an Internet connection wizard establishes the connection. Interfacing between the network devices is accomplished by assigning automatic private IP addresses for a LAN using TCP/IP (Transmission Control Protocol/Internet Protocol), which allows users to have a small network with assigned unique IP addresses to the network adapter of the Connection Sharing Computer using a “LINKLOCAL” network.

Generally, LINKLOCAL network addresses begin with 169.254 and are used for private, internal addresses and thus are not valid for host computers that are not visible on the Internet. More specifically, the IP addresses cannot be used for computers linked by Internet Connection Sharing, as Internet Connection Sharing networks use addresses in the 192.168.0.xxx range. Accordingly, after a network adapter of a network device is assigned a LINKLOCAL network IP address, network devices can communicate, using TCP/IP protocol, with any other network device on the local network that uses the same addressing.

Despite extensive sophistication, a typical charge per use LAN system recognizes only the Connection Sharing Computer on the local network, due to the direct connection thereof. Accordingly, once the initial, charged Internet connection is established, Internet Connection Sharing is executed to configure the Connection Sharing Computer among other network devices. Further, the Internet Connection Sharing may also be used to configure external devices on the LAN to use file and print sharing to access resources from one another. However, Internet Connection Sharing prevents access to the shared resource from the Internet.

Furthermore, network devices and hubs generally comprise a wide variety of connection types such as USB (universal serial bus), RJ-45 (a single-line jack for digital transmission over ordinary phone wire, either untwisted or twisted), Ethernet, and wireless, among others. Moreover, a variety of available power may exist for each of the network devices. Accordingly, setup and configuration of a portable local area network is time consuming and often requires additional equipment and resources.

Accordingly, there remains a need in the art for a system that provides for the rapid setup and configuration of a portable local area network for network devices, regardless of the connection method or available power, in order to share a common pay per use Internet connection.

### SUMMARY OF THE INVENTION

In one preferred form, the present invention provides a portable network mini-hub that comprises a plurality of modules and a plurality of ports such that a variety of connection methods and modes may be accommodated to rapidly setup a local area network. Generally, the modules comprise a wireless module for wireless access and an Ethernet hub module for Ethernet access. Further, a plurality of USB ports and a plurality of RJ ports are provided, which provide connections to the pay per use Internet services, the Connection Sharing Computer, and network devices.

Accordingly, a plurality of network devices communicate through the portable network mini-hub to form a portable local network such that a single pay per use Internet service may be shared amongst the network devices. Furthermore, the portable network mini-hub comprises a USB-Ethernet converter module with auto detect that allocates inputs to the portable network mini-hub. Further, the Ethernet hub is a standard four port module in one form of the present invention and the wireless module is an 8.11B input/output module.

Generally, the pay per use Internet services are provided through one of the RJ ports, and the Connection Sharing Computer is also connected to the portable network mini-hub through an RJ port. Further, network devices may connect to the portable network mini-hub through a USB port, an Ethernet connection, or through wireless access. Accordingly, the portable network mini-hub provides for rapid setup and configuration of a local area network, preferably within the environment of a mobile platform, e.g. commercial aircraft.

Although the following detailed description is directed to a mobile platform such as a commercial aircraft, the invention is also applicable to other modes of mass transit such as ship, train, bus, among others. Accordingly, the reference to commercial aircraft should not be construed as limiting the scope of the present invention.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a flow diagram of a portable network mini-hub in an exemplary network architecture in accordance with the present invention; and

FIG. 2 is a schematic of a portable network mini-hub in accordance with the present invention.

### DETAILED DESCRIPTION OF THE PREFERRED EMBODIMENTS

The following description of the preferred embodiments is merely exemplary in nature and is in no way intended to limit the invention, its application, or uses.

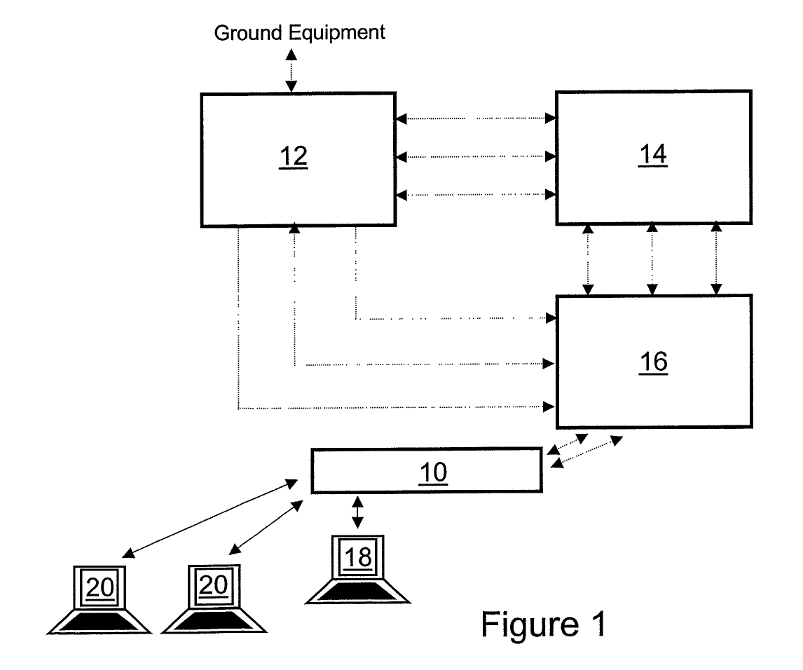

Referring to the drawings, a portable network mini-hub according to the present invention is illustrated and generally indicated by reference numeral 10 in FIG. 1. As shown, the portable network mini-hub 10 operates within an exemplary network architecture within a mobile platform that comprises a router 12 in communications with a server 14, a seat electronics box 16, a Connection Sharing Computer 18, and a plurality of network devices 20 as described in greater detail below.

Generally, the router 12 receives and transmits Internet services via air-to-ground communications and transmits the Internet services to the server 14 and to the seat electronics box 16 within the mobile platform. The Internet services are then transmitted through the portable network mini-hub 10, which transmits the data to a Connection Sharing Computer 18. The Connection Sharing Computer 18 then provides access to the Internet services for a plurality of network devices 20.

As further shown, the router 12 communicates with ground equipment to receive the Internet services and to transmit requests for Internet services from the Connection Sharing Computer 18 and the network devices 20. The communications between the router 12 and the ground equipment generally comprises routing and forwarding, IP multicast forwarding, traffic control, point to point protocol over Ethernet (PPPoE) access server, network address translation (NAT), and network time protocol (NTP). The router 12 then transmits and receives proxied web accesses and domain name service (DNS) queries to and from the server 14.

The server 14 is generally a web server, a proxy server, a DNS server, an authorization server, and a default gateway for additional local networks. Further, the server 14 transmits and receives web accesses and DNS queries to and from the seat electronics box 16. Accordingly, the seat electronics box 16 generally comprises address resolution protocol (ARP) proxies, PPPoE relays, a dynamic host configuration protocol (DHCP) mini-server, simple network time protocol (SNTP), NAT for static laptops, and multicast stream control. Further, the seat electronics box 16 transmits and receives non-proxied traffic and PPPoe from a virtual private network (VPN) to and from the router 12.

As further shown, Internet services are transmitted to the portable network mini-hub 10 from the seat electronics box 16, preferably using dynamic host configuration (DHC). Generally, the Connection Sharing Computer 18 establishes an initial, charged local area network connection. The Connection Sharing Computer 18 then serves as a controlling device for the network by providing Internet Protocol (IP) addresses and name resolution services for the network devices 20. The network devices 20 may then access the Internet through the Connection Sharing Computer 18 using private IP addressing translation. More specifically, when a network device 20 on the network sends a request to the Internet, its private address is transmitted to the Connection Sharing Computer 18, and the Connection Sharing Computer 20 then translates the IP address of the network device to its own Internet IP address and then sends it on to the Internet.

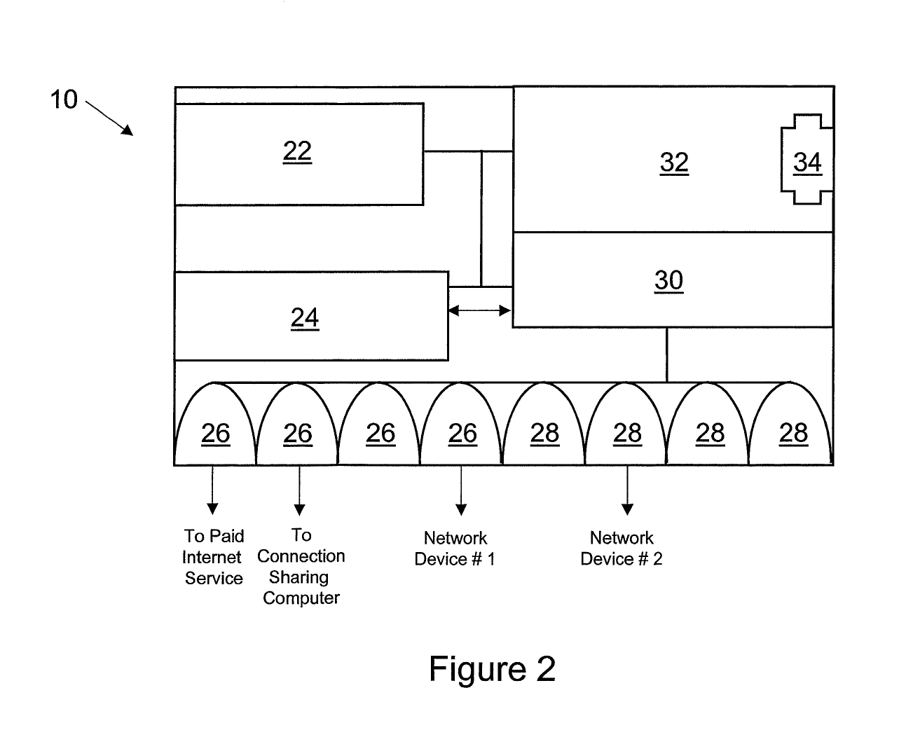

Referring to FIG. 2, the portable network mini-hub 10 comprises a plurality of modules to accommodate a variety of communication modes in addition to a plurality of ports that provide a connection to the portable network mini-hub 10 for a variety of network device connection types. Namely, the modules comprise a wireless module 22 for wireless access to the portable network mini-hub 10 and an Ethernet hub module 24 for Ethernet access. Additionally, the ports comprise RJ-45 ports 26 and USB ports 28 for direct connection to a network device as shown. Further, a USB-Ethernet converter module 30 is provided so that inputs may be auto detected and allocated accordingly.

In one form, the pay per use Internet service is provided to the portable network mini-hub 10 through an RJ port 26 as shown. Further, an RJ port 26 is used to connect the Connection Sharing Computer to the portable network mini-hub 10. Accordingly, network devices may be connected to the portable network mini-hub 10 through an RJ port 26, a USB port 28, or through wireless access to the wireless module 22 to form a portable local network on a mobile platform in order to share a common pay per use Internet connection. Preferably, the wireless module 22 is an 8.11B input/output module in one form of the present invention. Further, the Ethernet hub module 24 is a four port module.

As further shown, the portable network mini-hub 10 further comprises a power source 32, which may be a rechargeable battery pack with a built-in power converter charger. Further, the portable network mini-hub 10 may comprise an AC port 34, wherein external AC power may accessed for the power source 32.

Accordingly, the portable network mini-hub 10 is used to allow a plurality of network devices to operate as a LAN using Ethernet, USB, or wireless connections. A user connects a network device to the pay per use Internet service by the connection method required by the service and the Connection Sharing Computer. Once the initial connection is made, additional satellite devices may then be attached to the portable network mini-hub 10 and the appropriate software executed to provide sharing of a single pay per use Internet connection.

In another form, the portable network mini-hub 10 may be produced in a mini dual Ethernet/wireless configuration that is integrated in a PCMCIA (Personal Computer Memory Card International Association) card to operate from the Connection Sharing Computer. Accordingly, the PCMCIA configuration would be powered from the power supply of the Connection Sharing Computer and provide connection of a single additional network device to share the pay per use Internet service.

The description of the invention is merely exemplary in nature and, thus, variations that do not depart from the substance of the invention are intended to be within the scope of the invention. Such variations are not to be regarded as a departure from the spirit and scope of the invention.

What is claimed is:

1. A device that provides sharing of common pay per use mobile Internet services comprising:
a wireless module disposed within the device, the wireless module providing communications to the device for a plurality of network devices;
a plurality of USB ports disposed within the device, the USB ports providing communications to the device for the plurality of network devices;
a plurality of RJ ports disposed within the device, the RJ ports providing communications to the device for the Internet services;
an Ethernet hub disposed within the device, the Ethernet hub distributing data amongst the plurality of network devices; and
a power source that provides power to the device,
wherein the plurality of network devices communicate through the device to form a portable local network.

2. The device of claim 1 further comprising a USB-Ethernet converter module in communication with the Ethernet hub to further distribute data amongst the plurality of network devices.

3. The device of claim 1, wherein the Ethernet hub further comprises four ports.

4. The device of claim 1, wherein the device is disposed within a PCMCIA card in communication with a Connection Sharing Computer.

5. The device of claim 4, wherein the Connection Sharing Computer communicates with the device through one of the RJ ports.

6. The device of claim 1, wherein the wireless module is an 811.B wireless module.

7. The device of claim 1, wherein the power source is battery cells.

8. The device of claim 7, wherein the battery cells are rechargeable.

9. The device of claim 1, wherein the power source is AC.

10. A portable device for configuring a local network for a plurality of devices to access pay per use Internet services using different connections comprising:
a wireless module disposed within the portable device, the wireless module providing communications to the device for a plurality of network devices;
a plurality of USB ports disposed within the portable device, the USB ports providing communications to the device for the plurality of network devices;
a plurality of RJ ports disposed within the portable device, the RJ ports providing communications to the Internet services;
an Ethernet hub disposed within the portable device, the Ethernet hub distributing data amongst the plurality of network devices; and
a power source that provides power to the portable device,
wherein the plurality of network devices communicate through the portable device to form a portable local network.

11. The portable device of claim 10 further comprising a USB-Ethernet converter module in communication with the Ethernet hub to further distribute data amongst the plurality of network devices.

12. The portable device of claim 10, wherein the Ethernet hub further comprises four ports.

13. The portable device of claim 10, wherein the portable device is disposed within a PCMCIA card in communication with a Connection Sharing Computer.

14. The portable device of claim 13, wherein the Connection Sharing Computer communicates with the device through one of the RJ ports.

15. The portable device of claim 10, wherein the wireless module is an 811.B wireless module.

16. The portable device of claim 10, wherein the power source is battery cells.

17. The device of claim 16, wherein the battery cells are rechargeable.

18. The device of claim 10, wherein the power source is AC.
